(19) United States
(12) Patent Application Publication
(10) Pub. No.: US 2010/0235549 A1
(43) Pub. Date: Sep. 16, 2010

(54) COMPUTER AND INPUT/OUTPUT CONTROL METHOD

(76) Inventor: MASANORI KABAKURA, Tokyo (JP)

Correspondence Address: Mr. Jackson Chen, 6535 N. STATE HWY 161, IRVING, TX, 75039, US

(21) Appl. No.: 12/698,581

(22) Filed: Feb. 2, 2010

(30) Foreign Application Priority Data
Mar. 10, 2009 (JP) 56233/2009

(51) Int. Cl. G06F 3/00; G06F 9/455

(52) U.S. Cl. 710/40; 718/1

(57) ABSTRACT

A computer includes a priority storage part to store priority information which includes priority, the priority being set in advance per each of plural paths connecting a plurality of virtual servers and one or more storage devices, and per each kind of input/output command issued to the storage device by the virtual server, and a path management unit which selects a path out of the plural paths to destination of the input/output command on the basis of the kind of input/output command and the priority information and issues the input/output command to the selected path.

This application is based upon and claims the benefit of priority from Japanese Patent Application No. 2009-056233, filed on Mar. 10, 2009, the disclosure of which is incorporated herein in its entirety by reference.

### TECHNICAL FIELD

The present invention relates to a computer and an input/output control method, and specifically relates to a computer and an input/output control method in a virtual machine system.

### BACKGROUND ART

A virtual machine system is a computer system which includes one host operating system and one hypervisor and makes a plurality of guest operating systems operate by use of the hypervisor. Moreover, the virtual machine system is a kind of the computer system in which a plurality of operating systems shares a physical processor and a memory to operate.

Japanese Patent Application Laid-Open No. 2008-176482 discloses an example of the virtual computer system. The virtual computer system disclosed in the patent document 1 restrains a performance overhead in the case that virtual servers share an input/output device, and carries out arbitration and bandwidth control for input/output accesses on the basis of priority of the virtual server.

Further, Japanese Patent Application Laid-Open No. 2000-089998, as a related art, discloses a remote file controlling apparatus. The remote file controlling apparatus sets priority to each input/output command for updating data and then, carries out the input/output command on the basis of the priority.

Furthermore, Japanese Patent Application Laid-Open No. 1991-078856, as a related art, discloses an input/output processing apparatus. The input/output processing apparatus sets priority to each of access paths to an input/output apparatus and selects an access path, which should be used, on the basis of the priority.

### SUMMARY

An exemplary object of the invention is to provide a computer and an input/output control method, which may resolve a problem that it is impossible to carry out load distribution on the basis of characteristic of an input/output request.

A computer according to an exemplary aspect of the invention includes a priority storage part to store priority information which includes priority, the priority set in advance per each of the plural paths connecting a plurality of virtual servers and one or more storage devices, and per each kind of input/output command issued to the storage device by the virtual server, and a path management unit which selects a path out of the plural paths to destination of the input/output command on the basis of the kind of input/output command and the priority information and issues the input/output command to the selected path.

An input/output control method according to an exemplary aspect of the invention, storing priority information which includes priority to a computer system, the priority being set in advance per each of plural paths connecting a plurality of virtual servers and one or more storage devices and per each kind of input/output command issued to the storage device by the virtual server, and selecting a path out of the plural paths to destination of the input/output command on the basis of the kind of input/output command and the priority information and issues the input/output command to the selected path.

A computer according to an exemplary aspect of the invention includes priority storing means for storing priority information which includes priority, the priority being set in advance per each of plural paths connecting a plurality of virtual servers and one or more storage devices, and per each kind of input/output command issued to the storage device by the virtual server, and path management means for selecting a path out of the plural paths to destination of the input/output command on the basis of the kind of input/output command and the priority information, and issuing the input/output command to the selected path.

### BRIEF DESCRIPTION OF THE DRAWINGS

Exemplary features and advantages of the present invention will become apparent from the following detailed description when taken with the accompanying drawings in which:

FIG. 1 shows an configuration of a computer system according to a first exemplary embodiment of the present invention;

FIG. 2 is a table showing path information according to the first and a second exemplary embodiments of the present invention;

FIG. 3 is a table showing priority information according to the first and the second exemplary embodiments of the present invention;

FIG. 4 is a flowchart showing a path determining process according to the first and the second exemplary embodiments of the present invention;

FIG. 5 is a flowchart showing the path determining process according to the first and the second exemplary embodiments of the present invention;

FIG. 6 is a flowchart showing the path determining process according to the first and the second exemplary embodiments of the present invention;

FIG. 7 shows a configuration of an example of the computer system according to the first exemplary embodiment of the present invention;

FIG. 8 is a table showing the path information according to the example of the first and the second exemplary embodiments of the present invention;

FIG. 9 is a table showing the priority information according to the example of the first and the second exemplary embodiments of the present invention;

FIG. 10 shows a configuration of a computer system according to the second exemplary embodiment of the present invention;

FIG. 11 shows a configuration of a computer system according to a third exemplary embodiment of the present invention;

FIG. 12 is a table showing priority information according to the third exemplary embodiment of the present invention;

FIG. 13 is a flowchart showing a path determining process according to the third exemplary embodiment of the present invention; and

FIG. 14 is a flowchart showing the path determining process according to the third exemplary embodiment of the present invention.

### EXEMPLARY EMBODIMENT

Next, a first exemplary embodiment of the present invention will be described with reference to drawings.

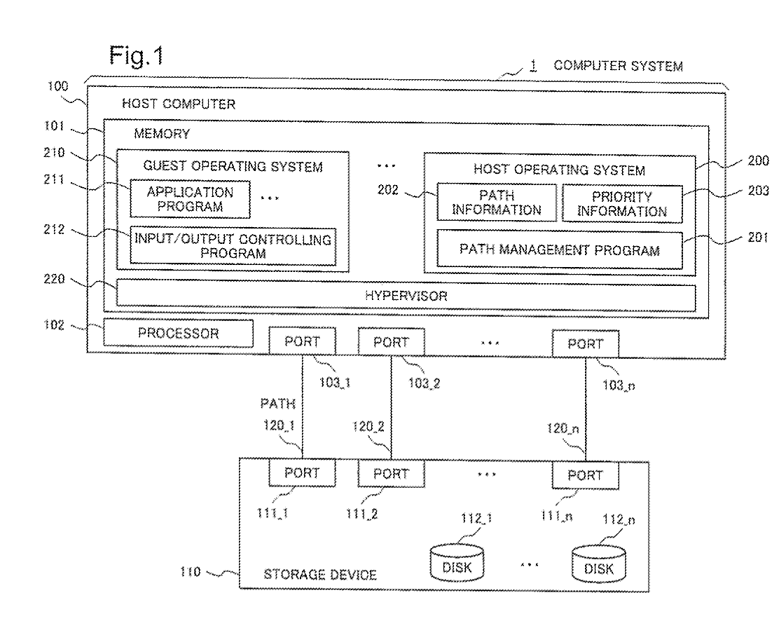

First, a configuration of computer system 1 will be described with reference to FIGS. 1 to 3 according to the first exemplary embodiment of the present invention.

FIG. 1 shows an example of the configuration of computer system 1 according to the first exemplary embodiment of the present invention. Computer system 1 includes one host computer 100, which works by program control, and storage device 110.

Host computer 100 and storage device 110 are connected together through path 120 (plural paths 120_1 to 120_{—}n), where n is arbitrary number.

Host computer 100 includes memory 101, processor 102 and port 103 (103_1 to 103_{—}n), where n is arbitrary number. Each of port 103 is assigned host side port identifier 302 which is unique in computer system 1.

Storage device 110 includes port 111 (111_1 to 111_{—}n) and disk 112 (112_1 to 112_{—}n), where n is arbitrary number. Each of port 111 is assigned storage side port identifier 303 which is unique in computer system 1. Moreover, each of disk 112 is assigned disk identifier 402 which is unique in computer system 1.

Path 120 (120_1 to 120_{—}n) is a logical path which connects each of port 103 of host computer 100 and each of port 111 of storage device 110. Each of path 120 is assigned path identifier 301 which is unique in computer system 1.

Further, it is possible to identify path 120 uniquely by use of path identifier 301 and it is also possible to identify path 120 uniquely by use of host side port identifier 302 and storage side port identifier 303.

Further, path 120 can be set by use of any connection method. For example, in case that the connection method adopts a fiber channel protocol, path 120 can be set by use of a fiber channel switch and fiber channel cables whose number is arbitrary.

Memory 101 stores one host operating system 200, guest operating systems 210 whose number is arbitrary, and hypervisor 220 which generates guest operating system 210.

According to the configuration of computer system 1, one host computer 100 includes a plurality of virtual servers.

Each of operating systems (host operating system 200 and guest operating system 210) can be activated separately on each virtual server. For this reason, host operating system 200 and guest operating system 210 share memory 101 and processor 102. Hypervisor 220 is a control program for realizing computer system 1, and controls guest operating system 210.

Host operating system 200 includes path management program 201, path information 202 and priority information 203. That is, path management program 201 works on host operating system 200.

Further, priority information 203 is also called a priority storage part.

Guest operating system 210 includes application programs 211 whose number is arbitrary, and input/output controlling program 212. That is, application program 211 and input/output controlling program 212 work on guest operating system 210.

Path management program 201 which works on host operating system 200 includes two functions. The first function is to determine path 120 which is a path to a destination of an input/output request issued from guest operating system 210. The second function is to manage an input/output process after receiving the input/output request which has been issued and processed completely. Further, detail on each function of path management program 201 will be described later.

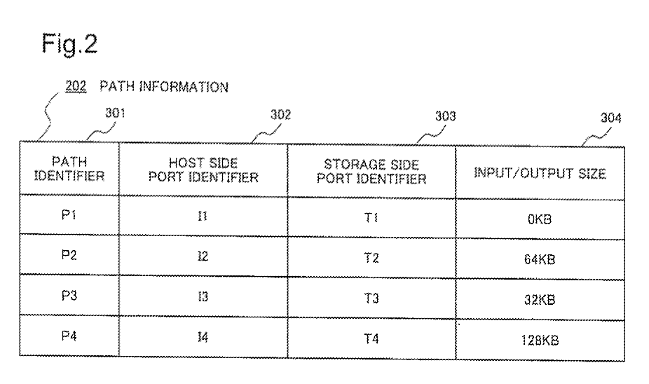

FIG. 2 is a table showing an example of structure of path information 202 which is stored in host operating system 200. Path information 202 indicates a state of the connection between host computer 100 and storage device 110. Path information 202 includes path identifier 301 which identifies path 120 uniquely, host side port identifier 302 of host side port 103 which connects to the path, storage side port identifier 303 of storage side port 111 which connects to the path, and input/output size 304 which indicates an amount of transferring input/output data which is being processed in the path.

Path management program 201 manages path information 202. In the case that path 102 is added in computer system 1, path management program 201 adds a new entry to path information 202. Similarly, in the case that path 102 is deleted, path management program 201 deletes the corresponding entry in path information 202.

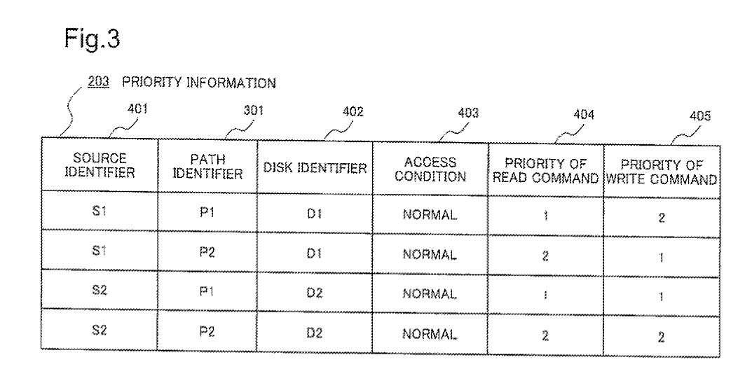

FIG. 3 is a table showing an example of structure of priority information 203 which is stored in host operating system 200. Priority information 203 indicates which path should be used with priority by guest operating system 210 in response to each of Read SCSI (Small Computer System Interface) command and Write SCSI command. Priority information 203 includes source identifier 401 which identifies uniquely guest operating system 210 issuing the input/output request, path identifier 301, disk identifier 402, access condition 403, priority of read command 404 and priority of write command 405.

Access condition 403 indicates whether it is possible to access disk 112, which is identified by disk identifier 402, through path 120 which is identified by path identifier 301. According to access condition 403, normality means to be in an accessible condition, and abnormality means to be in a not-accessible condition due to a fault or the like.

Priority of read command 404 and priority of write command 405 means priority of access to disk 112, which is identified by disk identifier 402, through path 120, which is identified by path identifier 301, in response to the read command and the write command in the corresponding entry. Each of priority of read command 404 and priority of write command 405 is set to a positive integer in advance. Large integer means that priority of read command 404 and priority of write command 405 include high priority. Then, path 120, which is corresponding to the entry with the highest priority of read command 404 and the highest priority write command 405, is selected to be used.

Path management program 201 manages priority information 203. In the case that path 120, guest operating system 210 and disk 112 are added in computer system 1, path management program 201 adds a new entry to priority information 203.

In the case that it is impossible to access to disk 112 due to a fault of at least one out of path 120, guest operating system 210 and disk 112, path management program 201 changes access condition 403 of priority information 203 to abnormality. In the case, path management program 201 does not delete the corresponding entry.

Path management program 201 changes access condition 403 of priority information 203 to normality at a time when it becomes possible to access disk 112 due to restoration from the fault.

Input/output controlling program 212 of guest operating system 210 is a program which controls the input/output from guest operating system 210 to outside of guest operating system 210. In the case that input/output controlling program 212 receives the input/output request from application program 211, input/output controlling program 212 adds source identifier 401 to the input/output request and then, issues the input/output request with the added source identifier 401 to hypervisor 220.

Then, hypervisor 220 transfers the input/output request to path management program 201 of host operating system 200.

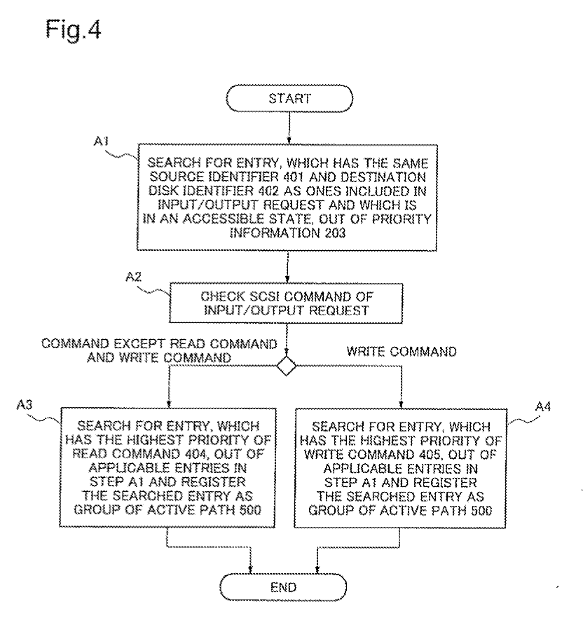

Next, an operation of computer system 1 will be described with reference to FIGS. 4 to 6 according to the first exemplary embodiment of the present invention.

FIGS. 4 to 6 are flowcharts showing an operation carried out at a time when path management program 201 receives the input/output request from input/output controlling program 212 and transfers the received input/output request to storage device 110.

First, an operation, in which path management program 201 determines active path group 500 as a candidate for the path to destination of the input/output request, will be described in the following with reference to FIG. 4.

In the case that path management program 201 receives the input/output request from input/output controlling program 212, path management program 201 searches for an entry which includes the same source identifier 401 and destination disk identifier 402 as ones included in the input/output request and whose access condition is normal, with reference to priority information 202 (Step A1).

Next, path management program 201 checks SCSI command of the received input/output request (Step A2). In the case that SCSI command is found to be the read command as a result of the check, path management program 201 searches for an entry which includes the highest priority of read command 404 out of the entries narrowed down at Step A1.

Further, in the case that there are a plurality of entries which include the highest priority of read command 404, path management program 201 determines that such entries are applicable. Then, path management program 201 keeps a group of path identifiers 301 of the applicable entries as active path group 500 (Step A3).

Here, the active path group means a group of paths which are used with priority in response to a input/output command which is issued from guest operating system 210 to disk 112.

Further, the input/output command is SCSI command of the input/output request, that is, the read command, the write command or the like.

In the case that SCSI command is found to be the write command as a result of the check in Step A2, path management program 201 carries out the same processing as the mentioned processing in Step A3, that is, path management program 201 searches for an entry which includes the highest priority of write command 405 out of the entries narrowed down in Step Al and registers the searched entry as active path group 500 (Step A4).

On the other hand, in the case that SCSI command is found to be neither the read command nor the write command, path management program 201 proceeds to Step A3 and carries out the same processing as one which is carried out in the case that SCSI command is the read command.

Further, in the case that the command is neither the read command nor the write command, an amount of transferring data of the command is lesser than one of the read command or the write command. Consequently, influence to system performance is considered negligible.

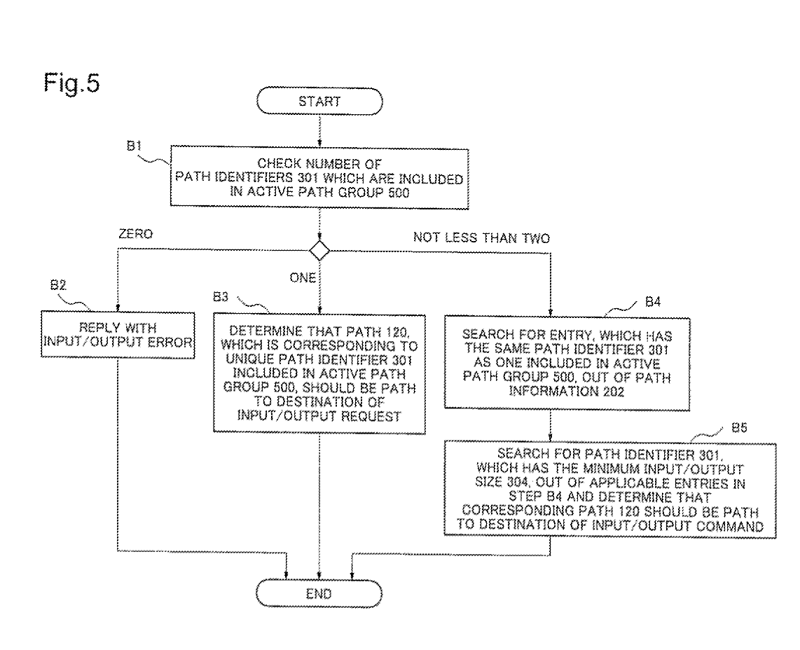

Next, an operation, in which path management program 201 determines path 120, which is the path to destination, out of registered active path group 500 after determining active path group 500, will be described with reference to FIG. 5.

Path management program 201 checks number of path identifiers 301 which are included in registered active path group 500 (Step B1). In the case that number of path identifiers 301 is found to be zero as a result of the check, there exists no path to which the input/output request can be issued. In the case, through replying to input/output controlling program 212 with an input/output error, path management program 201 notifies input/output controlling program 212 that it is impossible to issue the input/output request (Step B2).

In the case that number of path identifier 301 is found to be one as a result of the check in Step B1, path management program 201 determines that path 120, which is corresponding to unique path identifier 301, is the path to the destination of the input/output request (Step B3).

In the case that number of path identifiers 301 is not smaller than two as a result of the check in Step B1, path management program 201 searches for an entry which includes the same path identifier 301 as one included in active path group 500, with reference to path information 202 (Step 84).

Next, path management program 201 searches for one entry which includes the minimum input/output size 304 out of the entries, which are narrowed down in Step B4, of path information 202. Further, in the case that there exists a plurality of entries which include the minimum input/output size 304, path management program 201 determined that the entry, which is registered uppermost in path information 202, is applicable. Then, path management program 201 determines that path 120, which includes applicable path identifier 301, is the path to the destination of the input/output request (step B5).

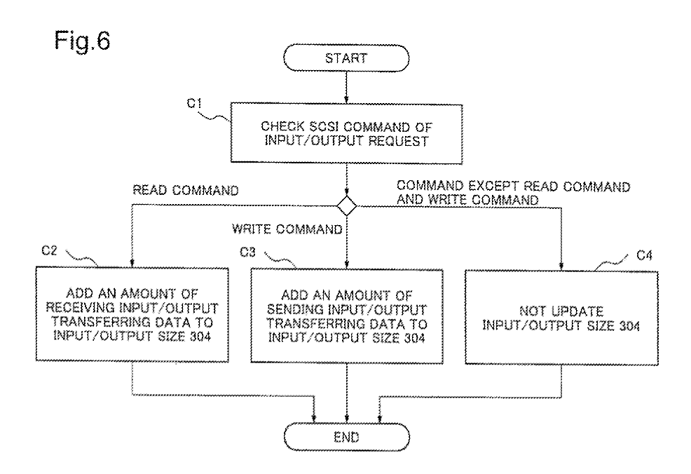

Next, an operation, in which, with regard to the entry of path information 202, path management program 201 updates input/output size 304 of the entry including the same path identifier 301 as one of the path to the destination after determining the path to the destination of the input/output request, will be described in the following with reference to FIG. 6.

Path management program 201 checks SCSI command of the received input/output request (Step C1). In the case that SCSI command is found to be the read command as a result of the check, path management program 201 adds an amount of the receiving input/output transferring data to input/output size 304 of path information 202 (Step C2).

Moreover, in the case that SCSI command is found to be the write command as a result of the check in Step C1, path management program 201 adds an amount of the sending input/output transferring data to input/output size 304 of path information 202 (step C3).

In the case that SCSI command is neither read command nor write command as a result of the check in Step C1, path management program 201 does not update input/output size 304 of path information 202 (Step C4).

Path management program 201 issues the input/output request to determined path 120 after completing to update the input/output size. Then, at a time when the input/output processing has been completed in response to the issued input/output request, the completion of the input/output processing is informed to path management program 201.

Further, the completion of the input/output processing is notified through transferring the completed input/output request to path management program 201 via path 120.

In the case that path management program 201 receives the notification on the completion of the input/output processing, path management program 201 updates input/output size 304 of the entry including path identifier 301 which is identical to path identifier 301 identifying path 120 to the destination of the input/output request, with regard to input/output size 304 of path information 202. Specifically, path management program 201 subtracts sending and receiving input/output data size, which has been added to input/output size 304 in Step C2 or Step C3, from input/output size 304.

Further, the sending and receiving input/output data size means size of transferring data in the input/output processing in response to the read command and the write command.

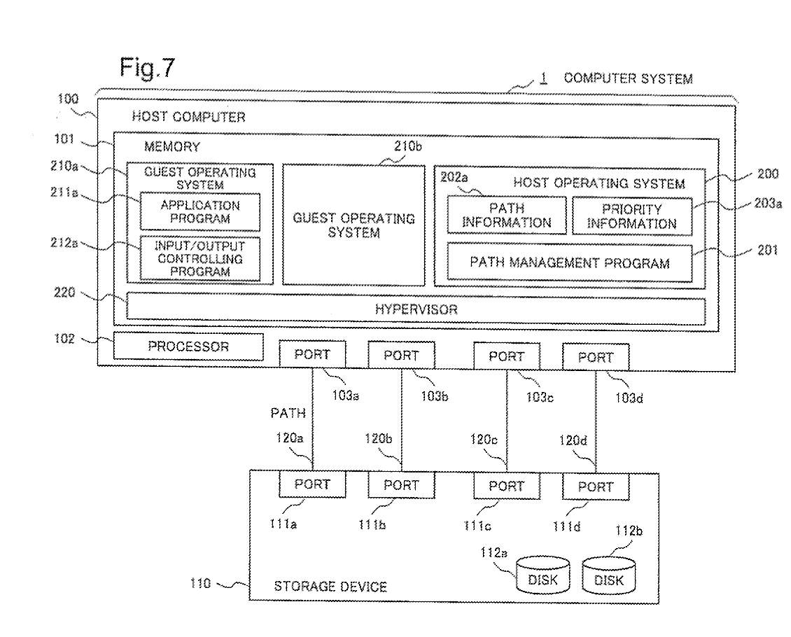

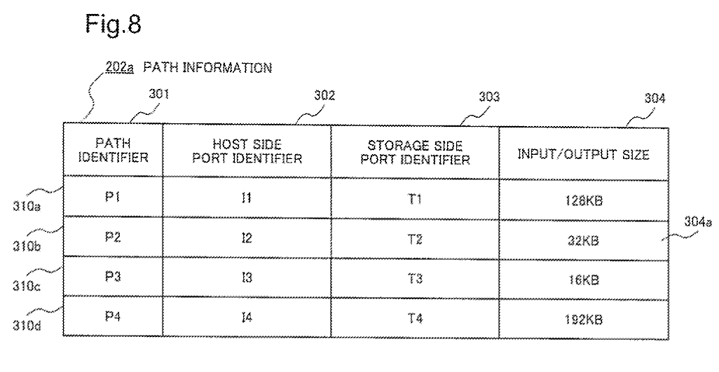

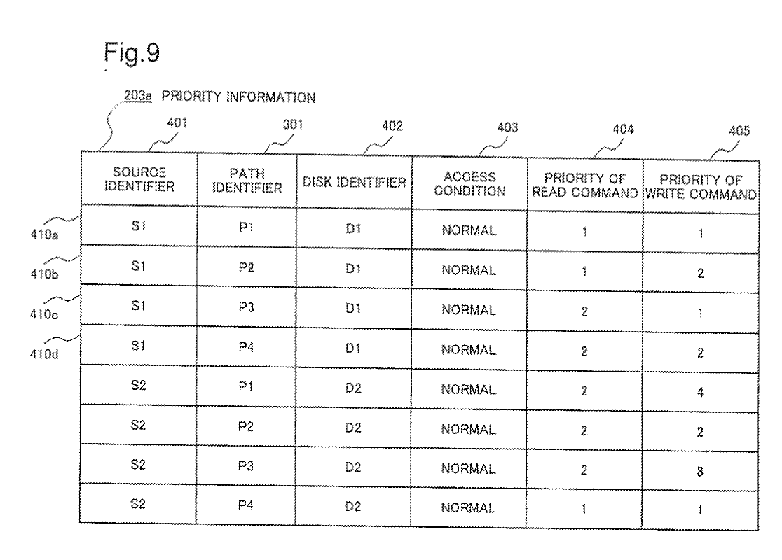

Next, an operation of computer system 1 will be described by use of a specific example with reference to FIGS. 7 to 9 according to the first exemplary embodiment of the present invention. Here, it is assumed that computer system 1 includes a configuration shown in FIG. 7. Moreover, it is assumed that path information 202a is set as shown in FIG. 8, and priority information 203a is set as shown in FIG. 9. Source identifiers 401 of guest operating systems 210a and 210b are denoted by S1 and S2 respectively. Disk identifiers 402 of disks 112a and 112b are denoted by D1 and D2 respectively. Host side port identifiers 302 of ports 103a, 103b, 103c and 103d are denoted by I1, I2, I3 and 14 respectively. Furthermore, storage side port identifiers 303 of ports 111a, 111b, 111c and 111d are denoted by T1, T2, T3 and T4 respectively.

According to the configuration shown in FIGS. 7 to 9, in the case that application program 211a on guest operating system 201a issues the write command with size of 64 kilobyte to disk 112a, the input/output request is transferred to path management program 201 through hypervisor 220.

Path management program 201 which receives the input/output request searches for an entry as a candidate for the destination of the input/output request, with reference to priority information 203a (Step A1 in FIG. 4). Here, according to the example shown in FIG. 9, each of entries 410a, 410b, 410c and 410d is applicable to the entry which is the candidate for the destination of the input/output request.

Next, path management program 201 checks the kind of SCSI command of the received input/output request (Step A2 in FIG. 4).

Here, since the received input/output request is the write command in this case, path management program 201 searches for an entry which includes the highest priority of write command out of the applicable entries in Step A1 (Step A4 in FIG. 4). According to the example shown FIG. 9, since it is found that entries 410b and 410d are applicable as a result of the search, path identifier 301 which are included in active path group 500 is found to be P2 and P4.

Next, path management program 201 checks number of path identifiers 301 included in active path group 500 (Step B1 in FIG. 5).

Here, since number of applicable path identifiers 301 is two in this case, path management program 201 searches for an entry, which includes the same path identifier 301 as one included in active path group 500, out of the entries of path information 202a (Step B4 in FIG. 5). Entries 310b and 310d are found to be applicable as a result of the search, in the case of the example shown in FIG. 8.

Next, path management program 201 searches for an entry which includes the minimum input/output size 304 out of the applicable entries in Step B4 (Step B5 in FIG. 5). According to the example shown in FIG. 8, since entry 310b is applicable as a result of the search, path management program 201 determines that path 120b identified by P2 of the path identifier 301 is a path to the destination of the input/output request.

Path management program 201 updates input/output size 304 of the path information 202a before issuing the input/output request to the determined path.

Specifically, path management program 201 checks firstly SCSI command of the received input/output request (Step C1 in FIG. 6).

Since SCSI command is the write command as a result of the check, path management program 201 updates input/output size 304b of entry 310b whose path identifier 320 is P2, with regard to input/output size 304 of path information 202a. Since an amount of input/output transferring data of the write command is 64 kilobyte in this case, path management program 201 updates input/output size 304b to 96 kilobyte by adding 64 kilobyte to 32 kilobyte (Step C3 in FIG. 6).

After completion of updating input/output size 304b, path management program 201 issues the input/output request to determined path 120b. Then, at a time when the issued input/output request has been processed, the input/output request is transferred to path management program 201. In the case that path management program 201 receives the transferred input/output request, path management program 201 restores input/output size 304b, which has been updated in Step C3, to the original size.

In this case, path management program 201 updates input/output size 304b to 32 kilobyte, where 32 kilobyte is equal to 64 kilobyte, which is an amount of the input/output transferring data, subtracted from 96 kilobyte.

As described above, the first exemplary embodiment of the present invention includes effects described below.

The first effect is that, in the case of determining the path to the destination of the input/output request, it is possible to determine the path on the basis of the priority in response to the read command and the write command. As a result, in the case that the read command, for example, is received as the input/output command from the virtual server which issues the read command frequently, it is possible to assign wide bandwidth to the input/output request.

The reason is that the path is determined by use of the priority of read command and the priority of write command to which the kind of input/output commands is taken into consideration.

The second effect is that it is possible to designate the path to the storage, which is the destination of the input/output request, per each virtual server. As a result, it is possible that, in the case that there exists a virtual server requiring wide bandwidth, all bandwidth of the path is assigned the server, or wide bandwidth is secured for the server through issuing the input/output request by use of a plurality of paths.

The reason is that the source identifier of the virtual server which issues the input/output request is included in the priority information, and the path is determined by use of the priority which is classified on the basis of the source identifier.

The third effect is that it is possible to secure availability even if a fault is caused along the path. As a result, it is possible to continue issuing the input/output request, even if a fault is caused along the path.

The reason is that there exists a plurality of paths to the destination of the input/output request, and condition of each path is managed on the basis of the access condition of the path information, and the input/output request is issued to the path whose access condition is normal.

Next, a second exemplary embodiment of the present invention will be described in detail with reference to a drawing.

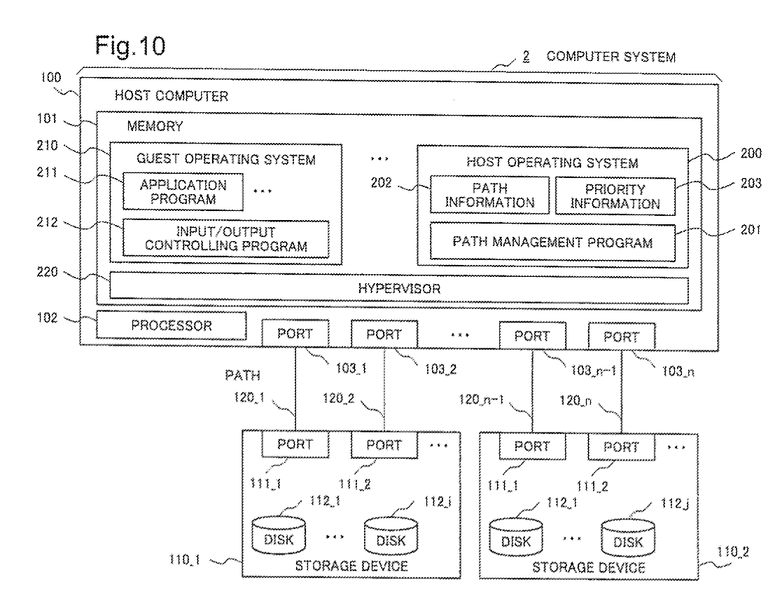

FIG. 10 shows an example of configuration of computer system 2 according to the second exemplary embodiment of the present invention. Computer system 2 includes one host computer 100 which operates by program control, and storage device 110 whose number is arbitrary.

Host computer 100 and storage device 110 are connected together through paths 120 whose number is arbitrary. According to the second exemplary embodiment of the present invention, computer system 2 is different from computer system 1 shown in FIG. 1 in a point that computer system 2 includes not smaller than two storage devices 110.

Further, while only two storage devices 110_1 and 110_2 are shown in FIG. 10, it may be preferable that computer system 2 includes not smaller than three storage devices 110.

Host computer 100 includes memory 101, processor 102 and port 103 (103_1 to 103_{—}n), where n is arbitrary number. Each of port 103 is assigned host side port identifier 302 which is unique in computer system 2.

Storage device 110_1 includes port 111 (111_1 to . . . ) whose number is arbitrary and disk 112 (112_1 to 112_{—}i), where i is arbitrary number. Each of port 111 is assigned storage side port identifier 303 which is unique in computer system 2. Each of disk 112 is assigned disk identifier 402 which is unique in computer system 2. Further, storage device 110_2 is assigned similarly storage side port identifier 303 and disk identifier 402.

Path 120 (120_1 to 120_{—}n) is a logical path which connects port 103 of host computer 100 and port 111 of storage devices 110a and 110b. Each of path 120 is assigned path identifier 301 which is unique in computer system 2.

Further, with regard to computer system 2, detailed description on host operating system 200 or the like which is stored in memory 101 is omitted, since host operating system 200 or the like includes the same configuration and carries cut the same operation as host operating system 200 or the like of the first exemplary embodiment of the present invention does.

According to computer system 2 of the second exemplary embodiment of the present invention, it is possible to identify storage side port identifier 303 and disk identifier 402 uniquely and consequently, it is possible to create a table on one path information 202 and priority information 203 with no duplication, with regard to different disk 112 of different storage device 110. For this reason, it is possible to determine the destination of the input/output command on the basis of path management program 201 by use of a method similar to one described in the first exemplary invention of the present invention.

As described above, the second exemplary embodiment of the present invention, in which number of disk devices 110 is extended to positive integer N (N is arbitrary number), includes an effect that it is possible to provide the computer system which includes the same effect as the computer system of the first exemplary embodiment of the present invention includes.

The reason is that storage device 110 is assigned storage side port identifier 303 and disk identifier 402 uniquely.

Next, a third exemplary embodiment of the present invention will be described in detail with reference to a drawing.

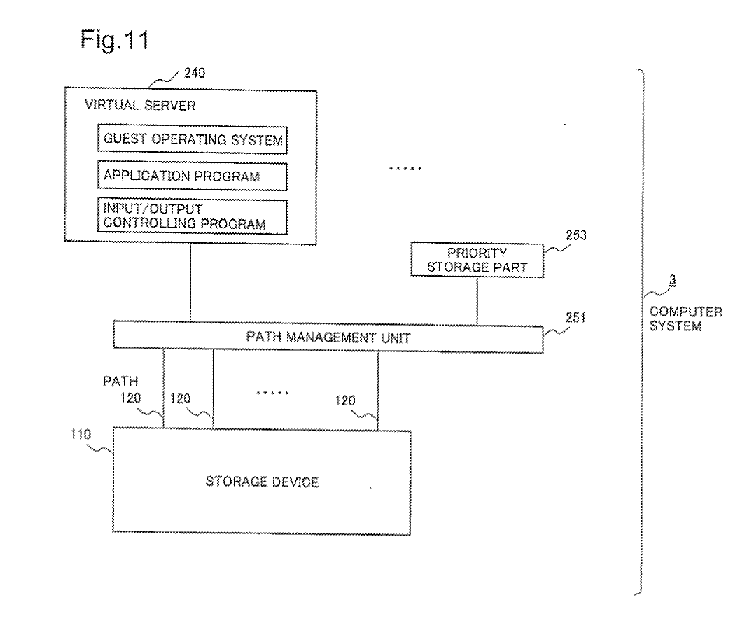

The third exemplary embodiment of the present invention includes a basic element of the first exemplary embodiment of the present invention. FIG. 11 shows an example of configuration of computer system 3 according to the third exemplary embodiment of the present invention.

Computer system 3 includes a plurality of virtual servers 240, storage device 110, a plurality of paths 120, priority storage part 253 and path management unit 251.

Each virtual server 240 is configured, for example, through being assigned a processor and a memory working on a host computer. A guest operating system, an input/output controlling program and an application program work on each virtual server 210.

It may be preferable that storage device 110 applies, for example, a disk apparatus and a disk array system.

Each path 120 connects virtual server 240 and storage device 110.

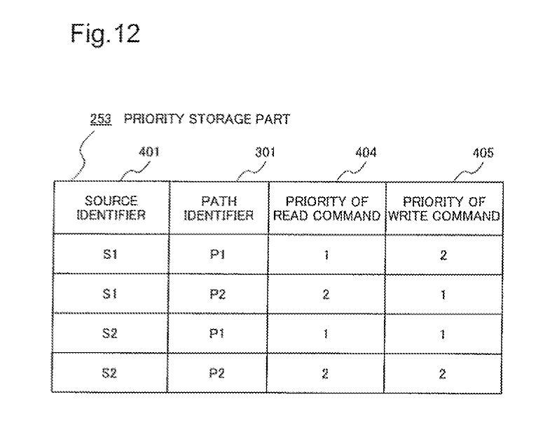

Priority storage part 253 stores priority information which includes priority, said priority being set in advance per each of a plurality of paths 120 and per each kind of the input/output commands issued to storage device 110 by virtual server 240. As shown in FIG. 12, priority storage part 253 includes source identifier 401, path identifier 301, priority of read command 404 and priority of write command 405.

Further, source identifier 401, path identifier 301, priority of read command 404 and priority of write command 405 are equivalent to ones described in the first exemplary embodiment of the present invention.

Path management unit 251 selects one or more path 120, which is the path to the destination of the input/output command, on the basis of kind of the input/output command and priority storage part 253 and issues the input/output command to selected path 120.

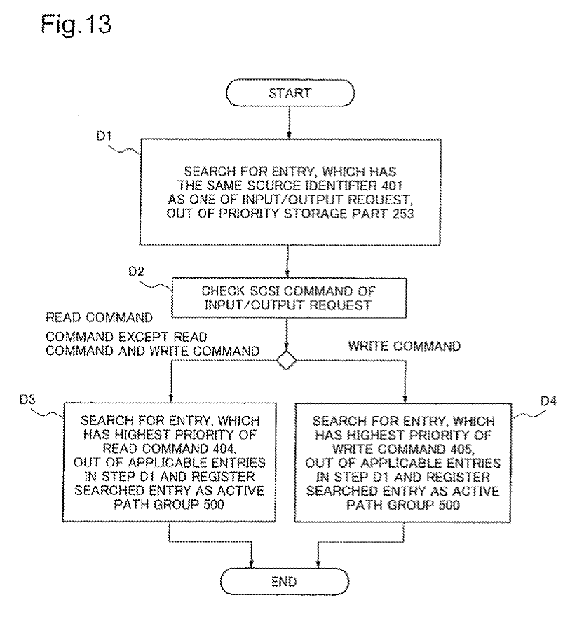

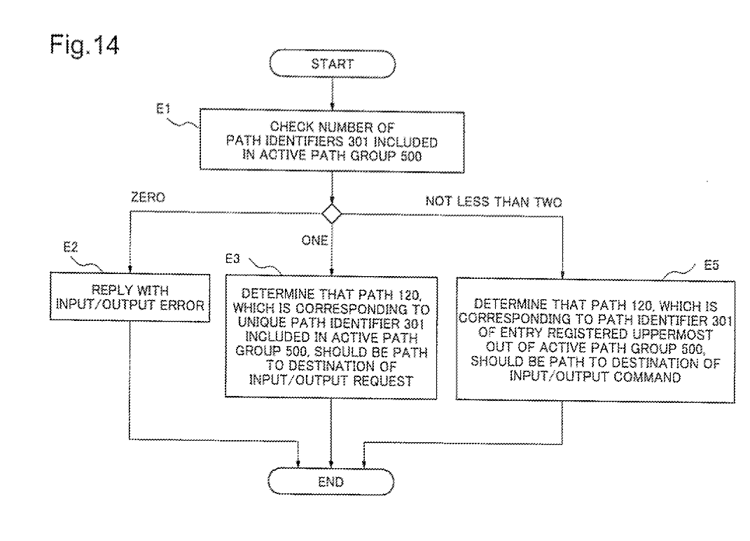

Next, an operation of computer system 3 will be described with reference to FIG. 13 and FIG. 14 according to the third exemplary embodiment of the present invention. FIG. 13 and FIG. 14 are flowcharts showing an operation carried out at a time when path management unit 251 receives the input/output request from virtual server 240 and transfers the received input/output request to storage device 110.

First, an operation, in which path management unit 251 determines active path group 500 as a candidate for the path to the destination of the input/output request, will be described with reference to FIG. 13.

In the case that path management unit 251 receives the input/output request from virtual server 240, path management unit 251 searches for an entry, which includes the same source identifier 401 as one included in the received input/output request with reference to priority storage part 253 (Step D1).

Next, path management unit 251 checks SCSI command of the received input/out request (Step D2).

In the case that SCSI command is found to be the read command as a result of the check, the path management unit 251 searches for an entry which includes the highest priority of read command 404 out of the entries narrowed down in Step D1. Further, in the case that there are a plurality of entries which include the highest priority of read command 404, path management unit 251 determines that such entries are applicable. Then, path management unit 251 keeps a group of path identifiers 301 of the applicable entries as active path group 500 (Step D3).

Here, the active path group means a group of paths which are used with priority in response to the input/output command which is issued from virtual server 240 to disk 112.

In the case that SCSI command is found to be the write command as a result of the check in Step D2, path management unit 251 carries out the same processing as the mentioned processing in Step D3, that is, path management unit 251 searches for an entry which includes the highest priority of write command 405 out of the entries narrowed down in Step D1 and registers the searched entry as active path group 500 (Step D4).

On the other hand, in the case that SCSI command is found to be neither read command nor write command, path management unit 251 proceeds to Step D3 and carries out the same processing as the processing which is carried out in the case that SCSI command is the read command.

Further, in the case that the command is neither read command nor write command, an amount of transferring data of the command is lesser than one of the read command or the write command. Consequently, influence to system performance is considered to be negligible.

Next, an operation, in which path management unit 251 determines path 120 to the destination out of registered active path group 500 after determining active path group 500, will be described with reference to FIG. 14.

Path management unit 251 checks number of path identifiers 301 which are included in registered active path group 500 (Step E1). In the case that number of path identifiers 301 is found to be zero as a result of the check, there exists no path to which the input/output request can be issued. In the case, path management unit 251 notifies input/output controlling program 212 that it is impossible to issue the input/output request, through replying to input/output controlling program 212 with an input/output error (Step E2).

In the case that number of path identifier 301 is found to be one as a result of the check in Step E1, path management unit 251 determines that path 120, which is corresponding to unique path identifier 301, is the path to the destination of the input/output request (Step E3).

In the case that number of path identifiers 301 is not smaller than two as a result of the check in Step E1, path management unit 251 determines that an entry, which is registered uppermost in path information 202, is applicable. Then, path management unit 251 determines that path 120 corresponding to applicable path identifier 301 is the path to the destination of the input/output request (Step E5).

As described above, according to the third exemplary embodiment of the present invention, it is possible to provide the computer system and the input/output control method by which load distribution can be carried out on the basis of characteristic of the input/output request.

The reason is that priority is set to each of a plurality of paths, to which the input/output request is issued from the virtual server, on the basis of characteristic of the input/output request and then, the path is selected on the basis of the priority.

A fourth exemplary embodiment of the invention is a computer system, in which a plurality of virtual servers share one or more disk devices, includes priority information, which defines priority of each of plural paths connecting any one of plural servers and the disk device in advance on the basis of kind of input/output command issued by the virtual server, and a path management means for selecting a path to destination of the input/output command on the basis of the priority information and issuing the input/output command to the selected path, in the case that the input/output command is issued by the virtual server.

Furthermore, a fifth exemplary embodiment of the invention is an input/output control method of a computer system in which a plurality of virtual servers share one or more disk devices. The method includes path management step in which, by use of priority information defining priority of each of plural paths connecting any one of plural servers and the disk device in advance on the basis of kind of input/output command issued by the virtual server, a path to destination of the input/output command is selected on the basis of the priority information and the input/output command is issued to the selected path, in the case that the input/output command is issued by the virtual server.

The related art described in the background art causes the following problems.

The first problem of the virtual computer system disclosed in Japanese Patent Application Laid-Open No. 2008-176482 is that the load distribution to the virtual servers, and the kind of input/output command are not taken into consideration.

The reason is that the related virtual server system, which is disclosed in the patent document 1, has no means to identify the kind of input/output command.

The second problem of the virtual computer system disclosed in Japanese Patent Application Laid-Open No. 2008-176482 is that, while arbitration and bandwidth control for the input/output access, which is generated within the server, are carried out, bandwidth for the access is restricted on the path to which the input/output command is issued.

The reason is that the path between the host computer and the storage device, which is the destination of the input/output command, is not taken into consideration.

The remote file controlling apparatus disclosed in Japanese Patent Application Laid-Open No. 2000-089998 sets priority to each command, in order to process the write command with priority because of time limitation of the write command. Here, priority indicates which portion of data should be processed first out of data to be processed in the read command and the write command.

That is, the priority described in Japanese Patent Application Laid-Open No. 2000-089998 specifies order of the processing of each portion of data, and does not indicates which path should be used first per each write command and read command.

For this reason, there is a problem that it is impossible to secure bandwidth for the input/output command by use of the high priority path, even if the priority defined in Japanese Patent Application Laid-Open No. 2000-089998 would be used.

Moreover, according to the input/output processing apparatus disclosed in Japanese Patent Application Laid-Open No. 1991-078856, priority is set to each access path and then, an access path is selected on the basis of the priority per each access so that the accesses do not concentrate on one access path fixedly.

That is, the priority defined in Japanese Patent Application Laid-Open No. 1991-078856 indicates which access path should be used by an upper rank apparatus. Therefore, if the upper rank apparatus is the same, an access path to be used per each access is the same.

For this reason, there is a problem that it is impossible to secure bandwidth for processing the command by use of high priority access path, in the case that the upper rank apparatus is the same.

An exemplary advantage according to the invention is to provide the computer system and the input/output control method by which the load distribution and the bandwidth control can be carried out on the basis of characteristic of the input/output request.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

(Further exemplary embodiment 1) A computer system, comprising:

a plurality of virtual servers;

one or more storage devices;

a plurality of paths each of which connects said virtual server and said storage device;

a priority storage part to store priority information which includes priority, said priority being set in advance per each of said plural paths and per each kind of input/output command issued to said storage device by said virtual server; and

a path management unit which selects a path out of said plural paths to destination of said input/output command on the basis of said kind of input/output command and said priority information and issues said input/output command to said selected path.

(Further exemplary embodiment 2) The computer system according to Supplement 1, wherein

said priority information further includes a source identifier which identifies said virtual server, said source identifier being set per each of said plural paths, and wherein

said path management unit selects said path to destination of said input/output command on the basis of said source identifier of said virtual server issuing said input/output command and on the basis of said priority.

(Further exemplary embodiment 3) The computer system according to Supplement 1, wherein

said priority information further includes access condition which indicates per each of said plural paths whether it is possible to access said storage device via said path or not, and wherein

said path management unit selects said path which is in an accessible state on the basis of said access condition, out of said plural paths on the basis of said priority.

(Further exemplary embodiment 4) The computer system according to Supplement 3, wherein

in the case that there are a plurality of active paths which are in said accessible state, said path management unit further selects said path to destination of said input/output command out of said active paths, on the basis of an mount of input/output transferring data which is being processed in each of said plural paths.

(Further exemplary embodiment 5) The computer system according to Supplement 1, wherein

said priority information includes priority of read command and priority of write command per each of said plural paths.

(Further exemplary embodiment 6) A computer readable medium recording :hereon embodying a program, enabling a computer to:

store priority information which includes priority, said priority being set in advance per each of said plural paths connecting a plurality of virtual servers and one or more storage devices and per each kind of input/output command issued to said storage device by said virtual server;

select a path out of said plural paths to destination of said input/output command on the basis of said kind of input/output command and said priority information; and

issue said input/output command to said selected path.

(Further exemplary embodiment 7) The computer readable medium according to Supplement 6, wherein

said priority information further includes a source identifier which identifies said virtual server, said source identifier being set per each of said plural paths, and wherein

said program further enabling the computer to:

select said path to destination of said input/output command on the basis of said source identifier of said virtual server issuing said input/output command and on the basis of said priority.

(Further exemplary embodiment 8) The computer readable medium according to Supplement 6, wherein

said priority information further includes an access condition which indicates per each of said plural paths whether it is possible to access said storage device via said path or not, said access condition being set per each of said plural paths, and wherein

said program further enabling the computer to:

select said path which is in an accessible state on the basis of said access condition, out of said plural paths on the basis of said priority.

(Further exemplary embodiment 9) The computer readable medium according to Supplement 8, said program further enabling the computer to:

in the case that there exists a plurality of active paths which are in said accessible state, select said path to destination of said input/output command out of said active paths, on the basis of an mount of input/output transferring data which is being processed in each of said plural paths, in the case that there are a plurality of said paths which are in an accessible state.

(Further exemplary embodiment 10) The computer readable medium according to Supplement 6, wherein

said priority information further includes a priority of read command and a priority of write command per each of said plural paths.

1. A computer, comprising:
a priority storage part to store priority information which includes priority, said priority being set in advance per each of plural paths connecting a plurality of virtual servers and one or more storage devices, and per each kind of input/output command issued to said storage device by said virtual server; and
a path management unit which selects a path out of said plural paths to destination of said input/output command on the basis of said kind of input/output command and said priority information and issues said input/output command to said selected path.

2. The computer according to claim 1, wherein
said priority information further includes a source identifier which identifies said virtual server, said source identifier being set per each of said plural paths, and wherein
said path management unit further selects said path to destination of said input/output command on the basis of said source identifier of said virtual server issuing said input/output command and on the basis of said priority.

3. The computer according to claim 1, wherein
said priority information further includes an access condition which indicates per each of said plural paths whether it is possible to access said storage device via said path or not, said access condition being set per each of said plural paths, and wherein
said path management unit selects said path which is in an accessible state on the basis of said access condition, out of said plural paths on the basis of said priority.

4. The computer according to claim 3, wherein
in the case that there exists a plurality of active paths which are in said accessible state, said path management unit further selects said path to destination of said input/output command out of said active paths, on the basis of an mount of input/output transferring data which is being processed in each of said plural paths.

5. The computer according to claim 1, wherein
said priority information further includes a priority of read command and a priority of write command per each of said plural paths.

6. An input/output control method,
storing priority information which includes priority to a computer system, said priority being set in advance per each of plural paths connecting a plurality of virtual servers and one or more storage devices, and per each kind of input/output command issued to said storage device by said virtual server, and
selecting a path out of said plural paths to destination of said input/output command on the basis of said kind of input/output command and said priority information and issues said input/output command to said selected path.

7. The input/output control method according to claim 6, wherein
said priority information further includes a source identifier which identifies said virtual server, said source identifier being set per each of said plural paths, and
selecting said path to destination of said input/output command on the basis of said source identifier of said virtual server issuing said input/output command and on the basis of said priority

8. The input/output control method according to claim 7, wherein
said priority information further includes an access condition which indicates per each of said plural paths whether it is possible to access said storage device via said path or not, said access condition being set per each of said plural paths, and
selecting said path which is in an accessible state on the basis of said access condition, out of said plural paths on the basis of said priority.

9. The input/output control method according to claim 8, wherein
in the case that there exists a plurality of active paths which are in said accessible state, further selecting said path to destination of said input/output command out of said active paths, on the basis of an mount of input/output transferring data which is being processed in each of said plural paths.

10. The input/output control method according to claim 6, wherein
said priority information further includes a priority of read command and a priority of write command per each of said plural paths.

11. A computer, comprising:
priority storing means for storing priority information which includes priority, said priority being set in advance per each of plural paths connecting a plurality of virtual servers and one or more storage devices, and per each kind of input/output command issued to said storage device by said virtual server; and
path management means for selecting a path out of said plural paths to destination of said input/output command on the basis of said kind of input/output command and said priority information, and issuing said input/output command to said selected path.
